(19) United States
(12) Patent Application Publication
(10) Pub. No.: US 2011/0215191 A1
(43) Pub. Date: Sep. 8, 2011

(54) Vortex left platform

(76) Inventor: William D. Gramling, (US)

(21) Appl. No.: 12/660,903

(22) Filed: Mar. 8, 2010

(51) Int. Cl. B64C 29/00; B64C 15/00; B64C 39/00

(52) U.S. Cl. 244/12.2

(57) ABSTRACT

Apparatus and method of using a generated vortex contained in a cylindrical enclosure to generate aerodynamic lift.

### FIELD OF THE INVENTION

Utilizing a generated vortex to achieve lift by moving air through airfoils contained in a cylindrical enclosure.

### BACKGROUND OF THE INVENTION

The present invention generates high velocity air and passes it as a vortex through mounted airfoils. The invention achieves three mechanisms to create lift. Presently, there exists small Coanda-Effect vortex-powered aircraft which use only a portion of the available energy in the moving air. The payload is restricted to just a few pounds, wherein the efficiency of the present invention permits personnel-carrying aircraft.

### SPECIFICATION

Referring to the drawings,

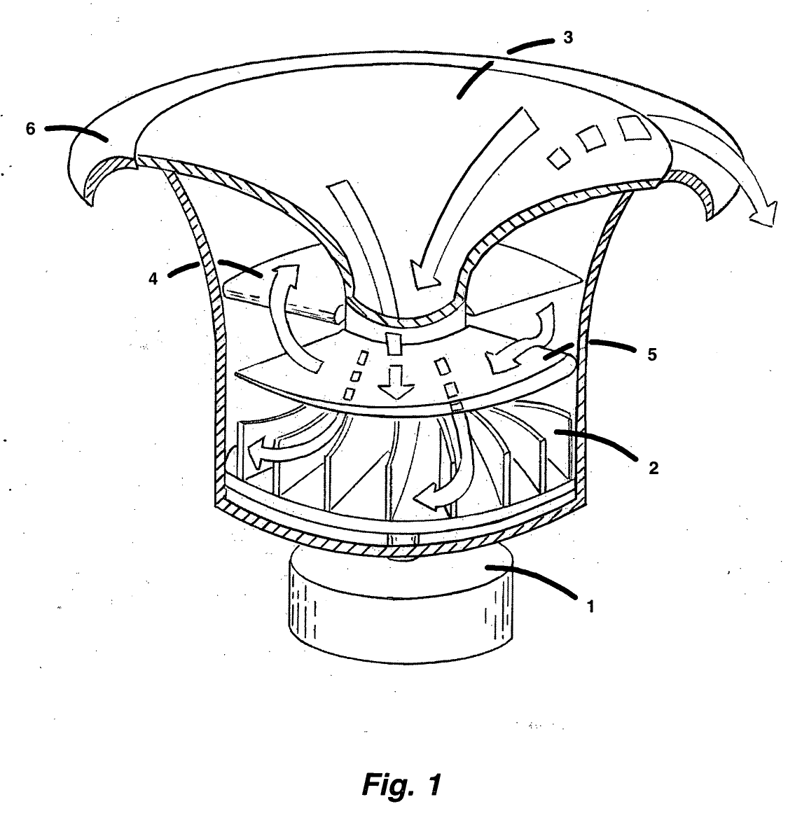

FIG. 1 shows a cut-away of the preferred embodiment.

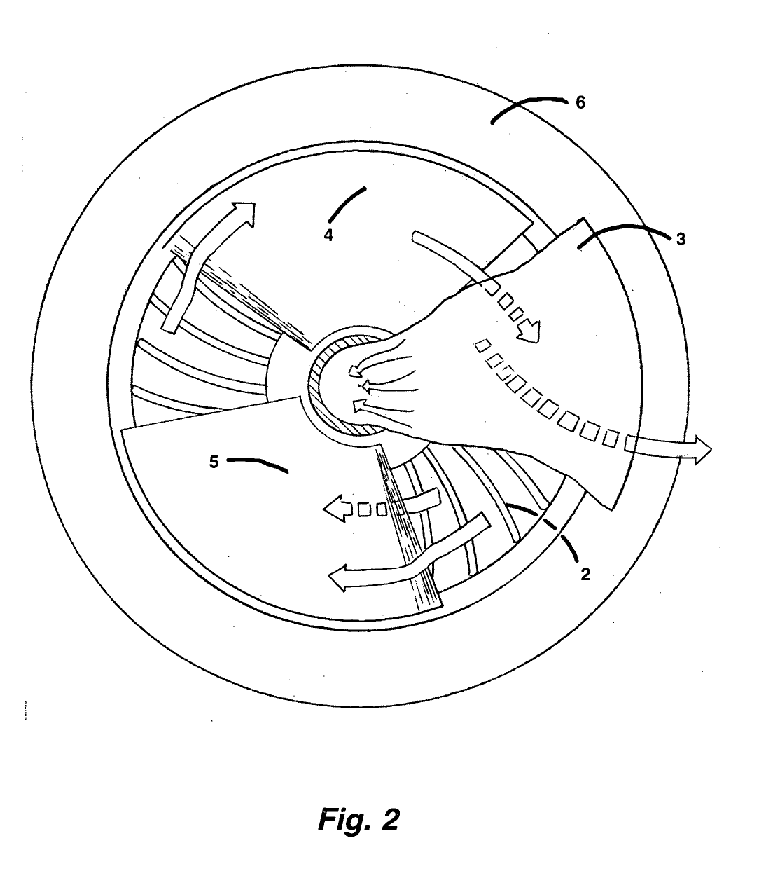

FIG. 2 is a cut-away top view.

Referring to FIG. 1, a power unit (1) which can be internal combustion, jet or electrical, rotates the impeller (2). Air is drawn in from the top down through the funnel-shaped input duct (3) into the center of the impeller. Arrows show the airflow. The impeller pushes the air into a high-velocity vortex flow. The vortex moves upward, contacting the airfoils (4, 5) which are positioned to give an ‘angle-of-attack’ relative to the air flow direction. A 15 degree angle-of-attack creates a high pressure under the airfoil and combined with the low pressure of the Coanda-Effect on the air passing over the airfoil, a high life component for each airfoil is achieved.

Only two airfoils are illustrated in the drawings for simplicity of presentation. Any number of airfoils can be installed, using an upwardly-staggered pattern.

As the high velocity air rises past the last, or highest airfoil, it is guided outwardly by the sloping underside of the input duct (3). The air flows over the downward-curved lip of the cylindrical housing (6), the low pressure on the surface of the lip gives the present invention additional lift through Coanda-Effect.

Thus, the Vortex Lift Platform creates lift in three ways: the high velocity air in and around the impeller creates a low pressure area and, since the ambient air under the housing (6) has a higher pressure, lift is achieved. Secondly, the air passing over and under the airfoils adds more lift. Then, thirdly, the vortex is guided out and down over the housing lip (6). Low pressure exists above the lip and higher pressure under the lip, completing the total lift quotient of the platform.

The spinning impeller (2) has a low pressure in the center, drawing air down through the input duct (3). A higher velocity can be gotten by extending the impeller drive shaft up through the duct to drive an additional air mover such as a propeller or turbine, pushing air down into the impeller center. Heat can be applied to the input air, reducing its density and increasing the lift in the impeller vicinity and the housing lip, but would reduce the lift supplied by the airfoils, due to the lower density.

Flat or curved vanes with a similar angle-of-attack could replace the airfoils, but would not produce similar lift.

An impeller is the most efficient air mover but a flat-bladed propeller would also suffice, as well as turbines. Also, high velocity air can be channeled into the housing (6) from a remote blower from below or above the impeller as long as a vortex is created.

Pilot-adjustable airfoil attack angles can be used to vary lift of individual platforms, giving altitude and directional control.

An aircraft can be configured with one or more Vortex Lift Platforms in any configuration, depending on the payload desired.

Having disclosed my invention, what I claim as new and to be secured by Letters Patent of the United States is:

1. Method and apparatus for aerodynamic lifting means comprising cylindrical enclosure, blower means and lift means.

2. Method and apparatus in accordance with claim 1 wherein lifting means include airfoils.

3. Method and apparatus in accordance with claim 1 wherein lift means include vanes.

4. Method and apparatus in accordance with claim 1 wherein blower means include impellers.

5. Method and apparatus in accordance with claim 1 wherein blower means include propellers.

6. Method and apparatus in accordance with claim 1 wherein blower means include turbines.

7. Method and apparatus for aerodynamic lifting means comprising cylindrical enclosure with upper curved lip, blower means and lift means.

8. Method and apparatus in accordance with claim 7 wherein lift means include airfoils.

9. Method and apparatus in accordance with claim 7 wherein lift means include vanes.

10. Method and apparatus in accordance with claim 7 wherein blower means include impellers.

11. Method and apparatus in accordance with claim 7 wherein blower means include propellers.

12. Method and apparatus in accordance with claim 7 wherein blower means include turbines.
